(19) United States
(12) Patent Application Publication
(10) Pub. No.: US 2004/0037912 A1
(43) Pub. Date: Feb. 26, 2004

(54) Machine for edge-milling concrete blocks not yet hardened

(76) Inventor: Robert Waltering, Rosendahl (DE)

Correspondence Address: Charles Guttman, Proskauer Rose, 1585 Broadway, New York, NY, 10036, US

(21) Appl. No.: 10/363,119

(22) PCT Filed: Sep. 3, 2001
(86) PCT No.: PCT/EP01/10131

(30) Foreign Application Priority Data
Dec. 9, 2000 (DE) 100 61 464.7

(51) Int. Cl. B28B 11/10

(52) U.S. Cl. 425/445; 425/289

(57) ABSTRACT

The invention relates to a machine for edge-milling (rumbling) concrete blocks (1) which have not yet hardened, having a horizontal conveyor (3) for transporting the concrete blocks (1) lying in one position on a support plate (2), and a hammer mechanism (4), arranged over the horizontal conveyor (3). The hammers (8) of this hammer mechanism (4) are arranged behind one another in several rows in the direction of transport and over a gap, so that they can hammer on the upper sides of the concrete blocks (1) laid under them. The individual hammers (8) are suspended on lifting drives (13-18).

The invention relates to a machine for edge-milling concrete blocks which are not yet hardened, having a horizontal conveyor for transporting the concrete blocks lying in one position on a support plate, and a hammer mechanism arranged over the horizontal conveyor, whose hammers, which are arranged behind one another in several rows in the direction of transport and over a gap, hammer on the surfaces of the concrete blocks moving past below them by means of a lifting drive.

Although machines of this type with sharp or blunt or rounded hammer heads have been known for some time (DE 36 21 276 A1 and EP 0 339 308 B1) edge-milling of concrete blocks, so-called rumbling, is still being carried out in practice in a drum. One reason for this may be that there is as yet no satisfactory solution.

The object of the invention is to provide a machine for edge-milling (rumbling) concrete blocks which have not yet hardened, which is robust in construction.

This task is solved according to the present invention by a machine of the type initially outlined in that the individual hammers are suspended on each lifting drive.

The suspension of the hammers has a smooth effect on the lifting drives and allows a mechanically simple, robust construction.

The hammers are preferably suspended on each row of hammers on a common lifting drive.

A simple lifting drive has a driven cam disc and a lifting mechanism supported on the cam disc. In particular the lifting mechanism can be supported via a multi-member articulated gear on the cam disc.

To adjust the power of impact, the articulated gear can have a lift adjustment. In particular the articulated gear consists of a rigid articulated polygon having at least three hinge points and an actuator adjustably in particular in length, which is hinged with its one end on the first hinge point of the articulated polygon and with its other end on an actuator, whereby the second hinge point of the articulated polygon is hinged on the lifting mechanism and the third hinge point of the articulated polygon forms the support of the lifting mechanism on the cam disc.

So that all the hammers do not hammer the blocks at the same time, the almost identical cam discs can be offset to one another.

The cam discs can be driven by a common shaft.

And to ensure that the concrete blocks resting on the support plate remain in the working reach of the hammers during processing, in the region of the hammer mechanism laterally also in the direction of transport guides, adjustable supports in particular, can be provided front and back set on the outer concrete blocks,.

As has proven advantageous for processing, if an impact-damping material path is tensed between the hammers and the concrete blocks, which on the one hand enables the edge to be broken off desirably, and on the other hand prevents the hammers hammering on the whole surface from leaving behind visible traces of impact.

Since the parts broken off from the edges lie partly on the surface of the blocks, and partly between the blocks, but these remains make later packaging of the individual positions difficult, a sweeping station for the upper surfaces is arranged behind the hammer mechanism, preferably in the direction of transport. In addition, a lifting mechanism for the concrete blocks and another sweeping station for the support plate are preferably arranged in the direction of transport behind the sweeping station. The support plate for the sweeping station is uncovered by the lifting mechanism when the concrete blocks are raised.

The invention will now be explained in greater detail hereinbelow with reference to a diagram illustrating an embodiment, in which:

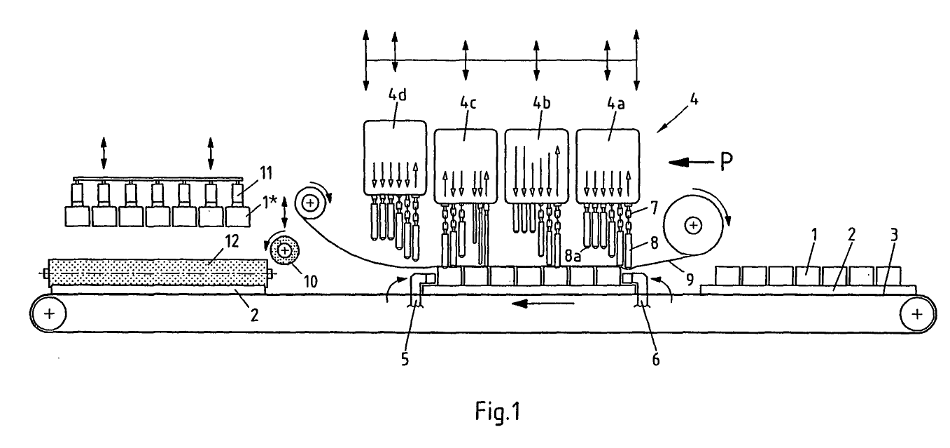

FIG. 1 diagrammatically illustrates a machine for edge-milling concrete blocks which have not yet hardened in a side elevation,

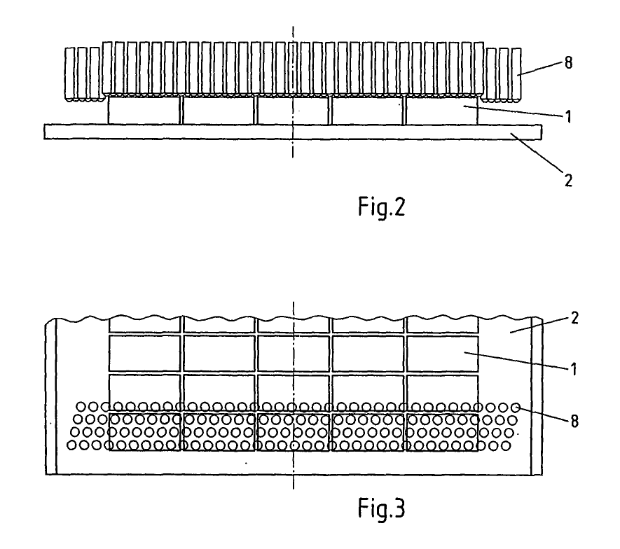

FIG. 2 illustrates the machine according to FIG. 1 in front elevation in the direction of the arrow P,

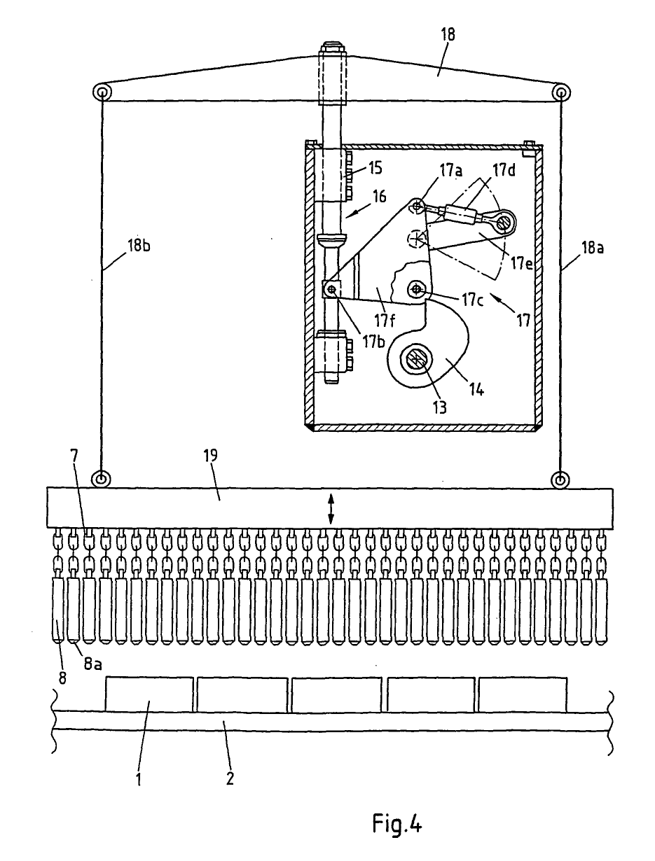

FIG. 3 illustrates the machine according to FIG. 1 in horizontal section just above the upper side of the concrete blocks,

FIG. 4 illustrates the machine according to FIG. 1 in a vertical section transverse to the direction of transport in detail with a row of hammers and their lifting drive, and

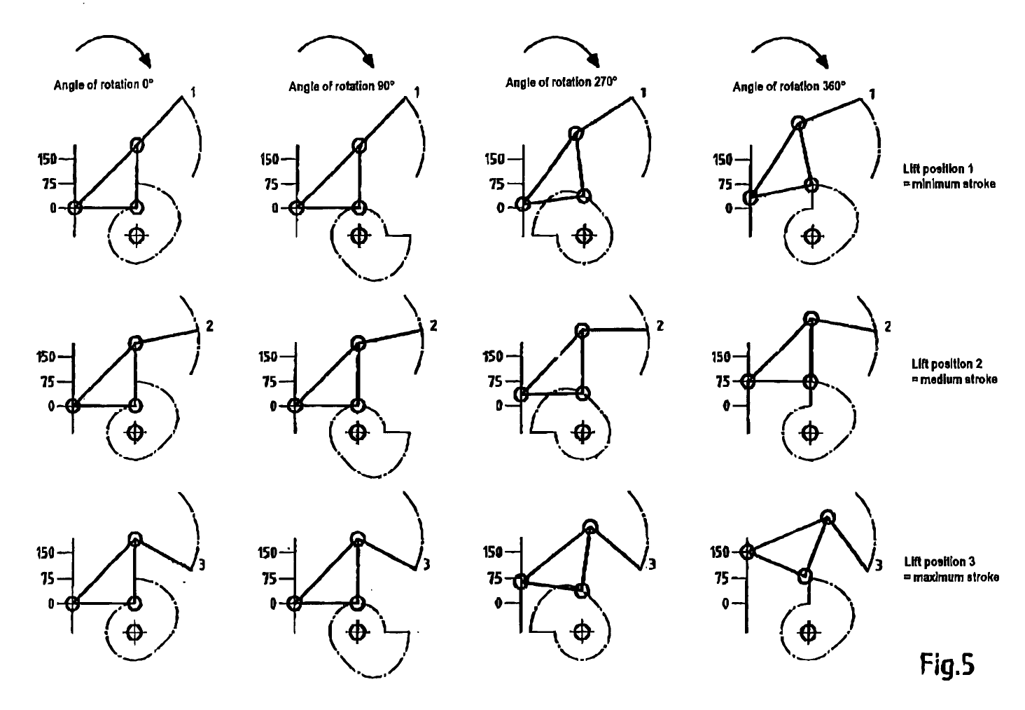

FIG. 5 diagrammatically illustrates the lifting drive according to FIG. 4 for different sized strokes in different phases of the stroke.

Concrete blocks 1, square for example, not yet fully hardened and to be broken at their edges rest evenly arranged on a plate-shaped support plate 2, which is transported by a conveyor belt 3 to a hammer mechanism 4. The hammer mechanism 4 comprises four identical units 4a, 4b, 4c, 4d, which in principle have the same structure. Each unit 4a-4d has a plurality of hammers 8 suspended on chains 7 with sharp, conical or pyramid-shaped hammer heads 8a, which, when not already artificially rounded during manufacture, are blunted by natural wear and tear during normal operation. The hammers 8 of each unit 4a-4d are arranged in several row behind one another and running transversely to the direction of transport. The hammers 8 are offset to one another from row to row, so that the whole surface can be impacted as the concrete blocks 1 pass by the hammers 8. Therefore it does not depend on the concrete blocks 1 being aligned with the hammers 8 with respect to their edges. The hammers 8 can also differ from unit to unit, even within one unit, as exemplified in FIG. 1 for unit 4c.

Stationary supports, not illustrated here, are provided in the region of the hammer mechanism 4 for the outer concrete blocks 1, guiding them laterally, and adjustable supports 5, 6, which are advanced along with the support plate 2, are provided in the region of the hammer mechanism for the concrete blocks 1 in the direction of transport front and back. They prevent the concrete blocks 1 from migrating sideways, whenever they are being processed by the hammers 8. Running between the hammers 8 and the top side of the concrete blocks 1 is a material path 9, for example a plastic foil. It serves to dampen the blows of the hammers 8, so that they do not leave behind any unwanted markings on the surface of the concrete blocks 1, though they do enable the edges to be broken off.

As they are being further transported the concrete blocks 1 pass a first sweeping station 10 in the form of a revolving brush. This sweeping station 10 is used to brush loosened concrete particles off the top side of the concrete blocks 1. After this the concrete blocks 1* now clean on their top side are raised by a lifting mechanism 11, so that the support plate 2 is uncovered with the superposed concrete particles. Then a second sweeping station 12 formed from a rotating brush travels over the support plate 2, which brushes the concrete particles from the support plate 2. The concrete blocks 1 are then again set down onto the clean support plate 2. The support plate 2 with the concrete blocks 1 is conveyed further to the side, where they are pushed together for packaging, without concrete particles lodged in gaps disrupting.

The lifting drive of each unit 4a, 4b, 4c, 4d illustrated in FIG. 4 in detail comprises a driven camshaft 13 and cam discs 14 arranged torsionally rigid thereon, rotationally offset from one another as well as a lifting mechanism 16 guided in a vertical guide 15, which is supported via an articulated gear 17 on the cam disc 14. With a bearer 18 the lifting mechanism 16 bears a beam 19 suspended on ropes 18a, 18b or articulated rods, which is guided in a vertical guide, not illustrated here. A row of hammers 8 individually is suspended by chains 7 on the beam 19. The articulated gear 17 exhibits a rigid articulated polygon with three hinge points 17a, 17b, 17c. The first hinge point 17 is hinged at one end of an actuator 17d adjustable in particular in length, whose other end is hinged on an actuator 17e to pivot about a solid fulcrum. The second hinge point 17b is hinged on the lifting mechanism 16, while the third hinge point 17c is supported on the curve 14. The advantages of such an articulated gear are that the stroke of the lifting mechanism 16 can be adjusted via the pivot position of the actuator 17e, without the lower dead point of the hammers 8 changing, and in that the entire curve of the cam disc 14 is utilised for each stroke, such that abrupt loading of the cam disc 14 cannot result, as would be the case with only partial sweeping of the cam disc 14.

FIG. 5 illustrates the individual phases of the lifting motion for various swivel positions of the actuator 17e. It is clearly seen here that with each adjustment made after the upper dead point of the lifting motion is reached (angle of rotation 360°) the support of the hinge point 17c begins at the starting point of the curve 14 (angle of rotation 0).

1. A machine for edge-milling concrete blocks which have not yet hardened, having a horizontal conveyor (3) for transporting the concrete blocks (1) lying in one position on a support plate (2) and a hammer mechanism (4), arranged over the horizontal conveyor (3), whose hammers (8), which are arranged behind one another in several rows in the direction of transport and over a gap, by means of a lifting drive hammer on the upper sides of the concrete blocks (1) moved past underneath them, characterised in that the individual hammers (8) are suspended on each lifting drive (13-18).

2. The machine as claimed in claim 1, characterised in that the hammers (8) of each row of hammers is suspended on a common lifting drive (13-18).

3. The machine as claimed in claim 1 or 2, characterised in that the lifting drive (13-18) in each case has a cam disc (14) and a lifting mechanism (16) supported on the cam disc (14).

4. The machine as claimed in claim 3, characterised in that the lifting mechanism (16) is supported by a multi-member articulated gear (17) on the cam disc (14).

5. The machine as claimed in claim 4, characterised in that the articulated gear (17) has a lift adjustment (17e, 17d).

6. The machine as claimed in claim 5, characterised in that the articulated gear (17) comprises a rigid articulated polygon having at least three hinge points (17a-17c) and an actuator (17d) adjustable in particular in length, which is hinged by one end on the first hinge point (17a) and by its other end on an actuator (17d), whereby the second hinge point (17b) of the articulated polygon is hinged on the lifting mechanism (16) and the third hinge point (17c) of the articulated polygon forms the support of the lifting mechanism (16) on the cam disc (14).

7. The machine as claimed in any one of claims 1 to 6, characterised in that in the region of the hammer mechanism (4) for the concrete blocks (1) lateral guides and/or in the direction of transport front and back adjustable supports (5, 6) are provided on the outer concrete blocks.

8. The machine as claimed in any one of claims 1 to 7, characterised in that an impact-damping material path (9) is tensed between the hammers (8) and the concrete blocks (1).

9. The machine as claimed in any one of claims 1 to 8, characterised in that a sweeping station (10) for the upper sides of the finished concrete blocks (1*) is arranged in the direction of transport behind the hammer mechanism (4).

10. The machine as claimed in claim 9, characterised in that a lifting mechanism (11) for the concrete blocks (1*) and another sweeping station (12) for the support plate (2) is arranged in the direction of transport behind the sweeping station (10).
